(19) United States
(12) Patent Application Publication
(10) Pub. No.: US 2022/0023895 A1
(43) Pub. Date: Jan. 27, 2022

(54) FLUID TANK HAVING STORAGE MEDIUM AND VALVE SYSTEM FOR AN ELECTRODYNAMIC ATOMIZER AND ATOMIZER AND METHOD FOR OPERATING THE ATOMIZER

(71) Applicant: J. WAGNER GmbH, Markdorf (DE)

(72) Inventors: SEBASTIAN MANGOLD, Salem (DE); MANUEL FIESEL, Friedrichshafen (DE); JENS ULBRICH, Friedrichshafen (DE); Hubert HILGER, Taufkirchen (Vils) (DE)

(21) Appl. No.: 17/309,724

(22) PCT Filed: Dec. 19, 2019
(86) PCT No.: PCT/EP2019/086280

§ 371 Date: Jun. 16, 2021

(51) Int. Cl. B05B 5/043; B05B 5/16; B05B 5/053

(52) U.S. Cl. CPC B05B 5/043; B05B 5/053; B05B 5/1691

(57) ABSTRACT

An electrohydrodynamic atomizer (Z), as well as a method for operating an electrohydrodynamic atomizer wherein the atomizer comprises an atomizer unit (ZE) and a fluid tank (1),

and the atomizer unit comprises the assemblies which are necessary for electrohydrodynamic atomization,
wherein at least one assembly comprises a high voltage generator (HV) which provides the high voltage which is necessary for the electrohydrodynamic atomization,
and at least one assembly comprises a pump system (P) in order to deliver the fluid which is to be atomized to an atomizer nozzle unit (D),
wherein the atomizer unit comprises an assembly with an electronic controller (S), in particular with at least one processor unit,
and wherein the fluid tank (1) comprises a data memory (10), wherein a means for exchanging data is formed between the fluid tank (1) and at least one assembly of the atomizer unit.

### CROSS-REFERENCES TO RELATED APPLICATIONS

This application is a Section 371 National Stage Application of International Application No. PCT/EP2019/086280, filed Dec. 19, 2019 and published as WO/2020/127711 A1 on Jun. 25, 2020, and claims priority to German Application No. 102018133459.1, filed Dec. 21, 2018, the contents of both are hereby incorporated by reference in their entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR A JOINT INVENTOR

Not Applicable

### BACKGROUND OF THE INVENTION

WO 2018 193 070 A1 discloses a fluid tank for an atomizer, in which electronic encoding of the fluid tank is provided by means of an RFID module arranged on the fluid tank.

Disadvantageous with such fluid tanks is that the encoding does not contain any information about the state of the fluid tank or its contents.

### BRIEF SUMMARY OF THE INVENTION

An electrohydrodynamic atomizer includes an atomizer unit, a fluid tank, and assemblies which are necessary for electrohydrodynamic atomization. At least one assembly comprises a high voltage generator which provides the high voltage which is necessary for the electrohydrodynamic atomization. At least one assembly comprises a pump system in order to deliver the fluid which is to be atomized to an atomizer nozzle unit. The atomizer unit comprises an assembly with an electronic controller, in particular with at least one processor unit. The fluid tank comprises a data memory, wherein a means for exchanging data is formed between the fluid tank and at least one assembly of the atomizer unit.

### BRIEF DESCRIPTION OF THE SEVERAL VIEWS OF THE DRAWING(S)

FIG. 1 shows an exploded sectional illustration of a fluid tank.

FIG. 2 shows an illustration of the fluid tank in section in an assembled embodiment.

FIG. 3a shows a plan view of an elastic valve body.

FIG. 3b shows a bottom view of an elastic valve body.

FIG. 4 shows the connecting region of the fluid tank connecting to an atomizer unit of an electrohydrodynamic atomizer.

FIG. 5 shows an atomizer with an atomizer unit and a fluid tank.

### DETAILED DESCRIPTION OF THE INVENTION

An object of an example of the invention is therefore to develop a fluid tank for an electrohydrodynamic atomizer in such a way that the functionality of an electrohydrodynamic atomizer is increased.

This object is achieved by means of an electrohydrodynamic atomizer as claimed in claim 1 and a method for operating such an electrohydrodynamic atomizer.

Advantageous developments and expedient refinements are specified in the dependent claims.

An example of the invention relates to an electrohydrodynamic atomizer, wherein the atomizer comprises an atomizer unit and a fluid tank. The atomizer unit in turn comprises the assemblies which are necessary for electrohydrodynamic atomization, wherein at least one assembly comprises a high voltage generator which provides the high voltage which is necessary for the electrohydrodynamic atomization, and at least one assembly comprises a pump system in order to deliver the fluid which is to be atomized to an atomizer nozzle unit. Wherein the atomizer unit also comprises an assembly with an electronic controller, in particular with at least one processor unit, and wherein the fluid tank comprises a data memory. The electrohydrodynamic atomizer is characterized in that a means for exchanging data is formed between the fluid tank and at least one assembly of the atomizer unit.

Providing the possibility for exchanging data, that is to say for transmitting data, in both directions, from the fluid tank to the atomizer unit and from the atomizer unit to the fluid tank, makes possible interactions which make possible an optimized operation of the electrohydrodynamic atomizer in a way which is adapted to the fluid tank.

A preferred embodiment provides here that the means for exchanging data is embodied as a read/write means.

A read/write connection makes it possible to obtain data from the data memory of the fluid tank and to write data into the data memory. This data can then comprise parameters which contain e.g. information about the quantity extracted on the basis of the pump delivery capacity, the time of the first activation or the like. As a result, open-loop or closed-loop control tasks can be triggered.

It is particularly preferred here that the data memory on the fluid tank can be written to by the electronic controller of the atomizer unit.

A central electronic control unit is preferred structurally on the atomizer unit, in order to evaluate the individual parameters such as e.g. the high voltage, pumping capacity and information from the fluid tank.

In order to carry out corresponding open-loop or closed-loop control tasks it is provided in one preferred embodiment that the high voltage generator can be closed-loop controlled, in particular can be closed-loop controlled in respect of its generated high voltage.

By means of a corresponding high voltage generator it is possible to set and optimize the high voltage which is made available for the electrohydrodynamic atomization, in accordance with the fluid tank which is used, the identification of which is stored in the data memory on the fluid tank.

In order to carry out corresponding open-loop or closed-loop control tasks it is provided in one alternative or supplementary preferred embodiment that the pump system can be closed-loop controlled, in particular can be closed-loop controlled in respect of its delivered quantity of fluid per unit of time.

By performing closed-loop control of the pump system it is possible for the hydraulic flow of fluid for the electrohydrodynamic atomization to be set and optimized in accordance with the fluid tank which is used, the identification of which is stored in the data memory on the fluid tank. On this basis it is possible to implement e.g. advantageous properties during the atomization by virtue of the fact that hydraulic effects assist the electrohydrodynamic atomization, for example by forming a hydraulic open jet in front of an atomizer nozzle.

Furthermore, a method for operating an electrohydrodynamic atomizer is provided, wherein an exchange of data between the fluid tank and at least one assembly of the atomizer unit brings about a switching process, open-loop control process or closed-loop control process.

By virtue of the exchange of data it is possible e.g. for the device to be enabled only when a permitted fluid tank is connected, in order to avoid malfunctions during the electrohydrodynamic atomization, in particular owing to the high voltage.

In this context, the exchange of data preferably takes place between the fluid tank and the assembly with an electronic controller, in order to provide a central control architecture which is as efficient as possible.

It is particularly advantageous here that the exchange of data comprises an identification step, in particular for adjusting a functional system between the fluid tank and atomizer unit.

By virtue of the execution of an identification step it is possible to obtain, from the data memory of the fluid tanks, information about the fluid contained in them, e.g. the age thereof, the operating time thereof since the first use and the residual filling quantity. On this basis it is possible to derive open-loop or closed-loop control tasks for the assemblies of the atomizer unit, with which the electrohydrodynamic atomizer is to be operated.

An embodiment in this regard provides that the high voltage which is generated by the high voltage generator is adapted, in particular by the electronic controller, as a function of the data from the data memory of the fluid tank.

In this way, the high voltage parameters can be adapted in a flexible way to the fluid for electrohydrodynamic atomization with process reliability.

As has already been described above, it can also preferably be provided that the flow of fluid which is generated by the pump system is adapted, in particular by the electronic controller, as a function of the data from the data memory of the fluid tank.

One advantageous development of an example of the invention provides that user-specific data and use-specific data are written into the data memory of the fluid tank via the electronic controller, wherein the data comprises, in particular, a time stamp, an operating time, an extraction volume or a user identification.

The description of the data memory permits a personal identification of the particular user to be noted on the data memory of the fluid tank. Moreover, data acquired on the basis of the volume which is delivered by the pump unit and relating to a remaining residual quantity of fluid in the fluid tank can be written into the data memory.

Furthermore, an example of the invention comprises a fluid tank, wherein the fluid tank comprises a data memory, in order to permit an exchange of data with the electrohydrodynamic atomizer, with an elastically deformable valve system.

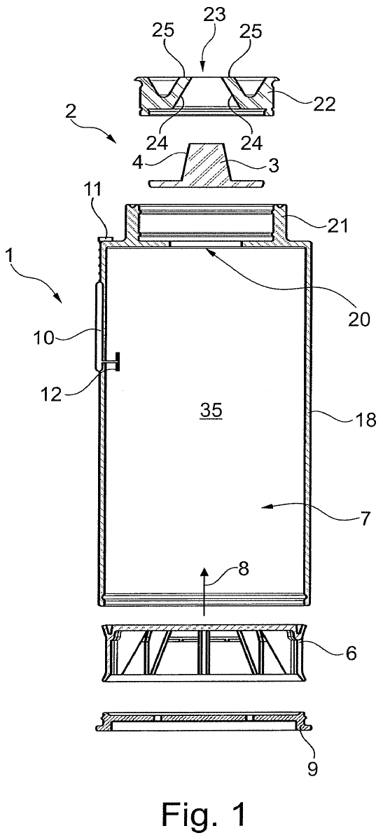

FIG. 1 shows in particular a fluid tank 1 for an electrohydrodynamic atomizer. The fluid tank 1 comprises an at least partially elastically deformable valve system 2, wherein the valve system 2 comprises an elastic valve body 3 with a conical sealing section 4 and a plurality of fluid channels 5 (illustrated in FIG. 3).

The fluid tank 1 also comprises a passive follower piston 6, which can be moved in the direction 8 from below into the tank volume 7. The follower piston 6 is pulled into the tank volume 7 during the extraction of fluid, for example by a peristaltic pump, and thereby permits ventilation of the tank volume 7 to be dispensed with.

The tank forms a housing for the fluid tank 1 on an underside with a cover 9 and the wall 18.

The fluid tank 1 can preferably comprise a data memory 10 and means for wired 11 and/or wireless formation of contact with the data memory 10. This is illustrated by way of example only in FIG. 1. The arrangement of the data memory 10 can be selected as desired here, in particular influenced by what installation space is available for the data memory 10.

The data memory 10 can particularly preferably also comprise electronic components such as, for example, sensors 12, in order to capture and store the temperature or other sensor data.

The tank volume has, on its upper side, an opening 20 which is surrounded by a valve seat 21. The elastic valve body 3 is inserted into the valve seat 21 and covered at the upper side in turn with a closure cap 22. The closure cap has in its center an opening 23 into which the conical sealing section 4 dips. The opening 23 comprises on its inner wall 24 a profile which is also conical so that this profile of this inner wall 24 forms a conical-conical seat seal together with the conical sealing section 4.

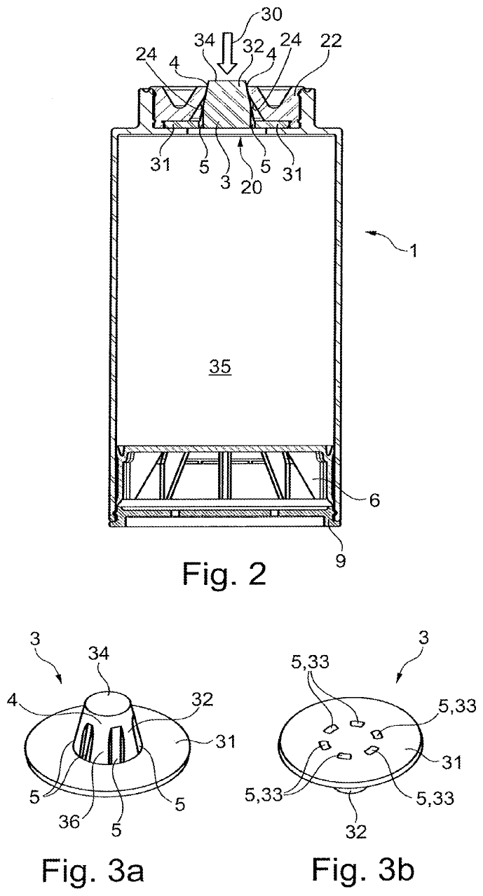

FIG. 2 illustrates a joined-together state of the components according to FIG. 1. Identical elements are provided with identical reference symbols.

The denoted valve system 2 is actuated to open by a force 30, which acts on the elastic valve body from above.

As illustrated in FIGS. 3a and 3b, the elastic valve body 3 comprises a spring disk 31 and a valve cone 32 which is arranged on the spring disk, wherein the valve cone 32 comprises the fluid channels 5, and the fluid channels 5 penetrate the spring disk 31 in the edge region of the valve cone 32 and form openings 33 on the underside of said spring disk 31.

At the upper edge of the valve cone 32 the conical sealing section 4 is formed, as illustrated in FIG. 3a.

If the force 30 illustrated in FIG. 2 then acts on the upper surface 34 of the elastic valve body 3, in particular of the valve cone 32, the valve cone is moved in the direction of the interior 35 of the fluid tank 1, as a result of which the spring disk 31 experiences deformation. In this way, a passage from the interior 35 of the fluid tank 1 through the fluid channels 5, between the outer surface 36 of the valve cone 32 and the inner wall 24 is cleared for the fluid.

When the force 30 disappears, the elasticity of the spring disk 31 can cause the valve cone 32 to be moved upward again and the sealing section 4 to form a seal with the inner wall 24. The valve therefore provides a way for fluid to be removed only when it is forcibly opened and is closed in the state of rest.

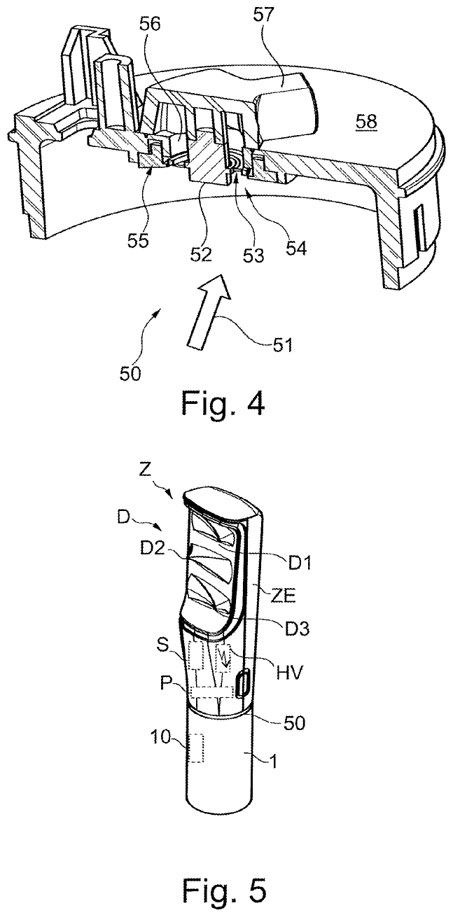

FIG. 4 shows the connecting region 50 on an atomizer unit ZE (not illustrated completely) of an electrohydrodynamic atomizer Z for a fluid tank 1. The fluid tank (not illustrated) is pushed in from below here and preferably secured by a bayonet system after slight rotation. The pushing in in the direction 51 causes, through the central arrangement of a stamp 52, the stamp 52 to be pressed against the upper surface 34 of the valve cone 32 and the valve to be opened as described above.

The connecting region 50 also comprises here a filter section 53, preferably composed of a stainless steel mesh which covers an annular region 54 through which the fluid enters the atomizer unit ZE from the fluid tank 1.

In addition to the filter section 53, which is located radially on the outside, a sealing element 55 is arranged which, with the upper surface of the closure cap, seals off from the surroundings the flow region of the fluid which is cleared when the valve system 2 is opened.

Above the flow region, in particular adjacent to the fluid paths 56, a hose connection 57 is provided, to which the hose channel/channels for connecting to the pump system P for the atomizer unit ZE are connected.

The stamp 52 is preferably engaged with the hose connection 57 here and therefore tensions it against the roof region 58 of the connecting region 50 via the filter 53 and the seal 55.

FIG. 5 shows a schematic view of an electrohydrodynamic atomizer Z, wherein the atomizer comprises an atomizer unit ZE and a fluid tank 1. The assemblies which are arranged within the atomizer unit ZE and are necessary for the electrohydrodynamic atomization are illustrated here by means of schematic symbols.

In this context, an assembly is a high voltage generator HV which provides the high voltage which is necessary for the electrohydrodynamic atomization. A further assembly relates to a pump system P for delivering the fluid to be atomized to an atomizer nozzle unit D with atomizer nozzles D1, D2, D3. Furthermore, the atomizer unit ZE comprises an assembly with an electronic controller S, in particular with at least one processor unit.

The fluid tank 1 comprises a data memory 10 which is also indicated schematically here. The fluid tank 1 is connected here to the atomizer unit ZE via the connecting region 50, as described above.

Although the present invention has been described with reference to preferred embodiments, workers skilled in the art will recognize that changes may be made in form and detail without departing from the spirit and scope of the invention.

### LIST OF REFERENCE SYMBOLS

1 Fluid tank
2 Deformable valve system
3 Elastic valve body
4 Conical sealing section
5 Fluid channel
6 Passive follower piston
7 Tank volume
8 Direction
9 Cover
18 Wall
10 Data memory
11 Wired formation of contact
12 Sensor
20 Opening
21 Valve seat
22 Closure cap
23 Opening of 22
24 Inner wall of 23
30 Force
31 Spring disk
32 Valve cone
33 Opening
34 Upper surface of elastic valve body 3
35 Interior of fluid tank 1
36 Outer surface of valve cone 32
50 Connecting region 50
51 Direction
52 Stamp
53 Filter/filter section
54 Ring region
55 Sealing element
56 Fluid paths
57 Hose connection
58 Roof region of connecting region 50
Z Atomizer
ZE Atomizer unit
HV High voltage generator
P Pump system
D Atomizer nozzle unit
D1, D2, D3 Atomizer nozzles
S Controller

1. An electrohydrodynamic atomizer, wherein the atomizer comprises an atomizer unit and a fluid tank,
and the atomizer unit comprises the assemblies which are necessary for electrohydrodynamic atomization,
wherein at least one assembly comprises a high voltage generator which provides the high voltage which is necessary for the electrohydrodynamic atomization,
and at least one assembly comprises a pump system in order to deliver the fluid which is to be atomized to an atomizer nozzle unit,
wherein the atomizer unit comprises an assembly with an electronic controller, in particular with at least one processor unit,
and wherein the fluid tank comprises a data memory,
wherein
a means for exchanging data is formed between the fluid tank and at least one assembly of the atomizer unit.

2. The electrohydrodynamic atomizer as claimed in claim 1, wherein the means for exchanging data is embodied as a read/write means.

3. The electrohydrodynamic atomizer as claimed in claim 1, wherein the data memory on the fluid tank can be written to by the electronic controller of the atomizer unit.

4. The electrohydrodynamic atomizer as claimed in claim 1, wherein the high voltage generator can be closed-loop controlled, in particular can be closed-loop controlled in respect of its generated high voltage.

5. The electrohydrodynamic atomizer as claimed in claim 1, wherein the pump system can be closed-loop controlled, in particular can be closed-loop controlled in respect of its delivered quantity of fluid per unit of time.

6. A method for operating an electrohydrodynamic atomizer as claimed in claim 1, wherein an exchange of data between the fluid tank and at least one assembly of the atomizer unit brings about a switching process, open-loop control process or closed-loop control process.

7. The method as claimed in claim 6, wherein the exchange of data takes place between the fluid tank and the assembly with an electronic controller.

8. The method as claimed in claim 6, wherein the exchange of data comprises an identification step, in particular for adjusting a functional system between the fluid tank and atomizer unit.

9. The method as claimed in claim 6, wherein the high voltage which is generated by the high voltage generator is adapted, in particular by the electronic controller, as a function of the data from the data memory of the fluid tank.

10. The method as claimed in claim 6, wherein the flow of fluid which is generated by the pump system is adapted, in particular by the electronic controller, as a function of the data from the data memory of the fluid tank.

11. The method as claimed in claim 6, wherein user-specific data and use-specific data are written into the data memory of the fluid tank via the electronic controller, wherein the data comprises, in particular, a time stamp, an operating time, an extraction volume or a user identification.

12. A fluid tank for an electrohydrodynamic atomizer, wherein the fluid tank comprises a data memory, in order to permit an exchange of data with the electrohydrodynamic atomizer, wherein the fluid tank comprises an at least partially elastically deformable valve system, wherein the valve system comprises an elastic valve body with a conical sealing section and a plurality of fluid channels.

13. The fluid tank as claimed in claim 12, wherein the fluid tank comprises a passive follower piston.

14. The fluid tank as claimed in claim 12, wherein the elastic valve body comprises a spring disk and a valve cone which is arranged on the spring disk, wherein the valve cone comprises the fluid channels, and the fluid channels penetrate the spring disk in the edge region of the valve cone.

15. The fluid tank as claimed in claim 12, wherein the fluid tank also comprises means for wired and/or wireless formation of contact with the data memory.
